(19) United States
(12) Patent Application Publication
(10) Pub. No.: US 2014/0198494 A1
(43) Pub. Date: Jul. 17, 2014

(54) Lighting Unit and Light Bar having the Same

(71) Applicant: Lextar Electronics Corporation, Hsinchu (TW)

(72) Inventor: Shih-Chieh Chin, Nantou County (TW)

(73) Assignee: Lextar Electronics Corporation, Hsinchu (TW)

(21) Appl. No.: 14/152,124

(22) Filed: Jan. 10, 2014

(30) Foreign Application Priority Data
Jan. 17, 2013 (TW) 102101777

(51) Int. Cl. F21K 99/00

(52) U.S. Cl. CPC F21K 9/56
USPC 362/217.14; 362/293; 362/382

(57) ABSTRACT

A lighting unit is provided and includes a cup body, a substrate, a first conductive wire connector and a second conductive wire connector. The cup body has a light emitting surface, a first end portion, and a second end portion. The substrate is located in the concave accommodating cavity of the cup body. A lighting element is located on the substrate, and has a light emitting direction toward the light emitting surface. The first and second conductive wire connectors are respectively located at two sides of the substrate in the accommodating cavity. A portion of the first conductive wire connector protrudes from the surface of the first end portion to form a first male connection terminal. The second conductive wire connector is recessed in the surface of the second end portion to form a first female connection terminal.

### RELATED APPLICATIONS

This application claims priority to Taiwan Application Serial Number 102101777, filed Jan. 17, 2013, which is herein incorporated by reference.

### BACKGROUND

1. Field of Invention

The present invention relates to a lighting unit and a light bar having the lighting unit.

2. Description of Related Art

Light emitting diodes (LEDs) are semiconductor elements. Along with the progress of technology, the LEDs are not only applied as indicators of electronic devices or lighting elements of display panels, but used in thin profile televisions, computer monitors, and general lighting apparatus. The LEDs have the advantages such as long lifespan, low energy consumption, small size, good shock resistance, and a wide variety of usages.

A conventional LED light bar is equipped with the LEDs and a printed circuit board. The light bar is manufactured by soldering the LEDs on the printed circuit board. As such, the arrangement of the LEDs on the printed circuit board is limited by the layout of electric circuits of the printed circuit board. In automatic production of the LED light bar, the LEDs are soldered on the printed circuit board by means of surface mount technology (SMT), and so this usually consumes a long time in the manufacturing process of the LED light bar.

In addition, after long term use of the conventional LED light bar, some LEDs may be totally damaged or reduced in brightness. Since the LEDs are soldered on the printed circuit board, it is difficult to replace the damaged LEDs. Moreover, the conventional LED light bar is configured to emit light in uni-directional (i.e., a direction facing away from the printed circuit board), which limits the light emitting angle of the conventional LED light bar.

### SUMMARY

An aspect of the present invention is to provide a lighting unit.

According to one embodiment of the present invention, a lighting unit includes a cup body, a substrate, and a first conductive wire connector and a second conductive wire connector. The cup body has a light emitting surface, a first end portion, and a second end portion facing away from the first end portion. The first and second end portions are adjacent to the light emitting surface. The cup body has a concave accommodating cavity. The substrate is located in the accommodating cavity. A lighting element is located on the substrate, and a light emitting direction of the lighting element is toward the light emitting surface. The first and second conductive wire connectors are respectively located at two sides of the substrate in the concave accommodating cavity. The lighting element is electrically connected to the first and second conductive wire connectors. A portion of the first conductive wire connector protrudes from a surface of the first end portion to form a first male connection terminal. The second conductive wire connector is recessed in a surface of the second end portion to form a first female connection terminal.

In one embodiment of the present invention, the first end portion of the cup body is a concave structure, and the second end portion of the cup body is a protruding structure.

In one embodiment of the present invention, a surface of the concave structure further has a positioning protruding part, and the protruding structure has a positioning cavity.

In one embodiment of the present invention, cross-sectional shapes of the concave structure and the protruding structure comprise rounds or polygons to fit together.

In one embodiment of the present invention, the lighting element is a light emitting diode.

In one embodiment of the present invention, the lighting unit further includes an encapsulant. The encapsulant is formed on the light emitting diode.

In one embodiment of the present invention, the encapsulant further includes a wavelength conversion material.

In one embodiment of the present invention, the wavelength conversion material includes phosphor, pigment, dye, or combinations thereof.

An aspect of the present invention is to provide a light bar.

According to one embodiment of the present invention, a light bar includes N lighting units that are connected in series, and N is a natural number. The first male connection terminal of the first end portion of the i-th lighting unit is coupled to the first female connection terminal of the second end portion of the j-th lighting unit adjacent to the i-th lighting unit, such that the i-th lighting unit is electrically connected to the j-th lighting unit adjacent to the i-th lighting unit. 1≦i≦j≦N, and i and j are positive integers.

In one embodiment of the present invention, the light emitting surfaces of the lighting units faces the same direction or different directions.

In one embodiment of the present invention, the light bar further includes a plurality of interval units. The interval units are located between the lighting units. Each of the interval units includes a second cup body. The second cup body has a third end portion, a fourth end portion facing away from the third end portion, and a conductive element therein. An end of the conductive element protrudes from the third end portion to form a second male connection terminal, and another end of the conductive element is recessed in the fourth end portion to form a second female connection terminal. The second male connection terminal of each of the interval units is coupled to the first female connection terminal of the lighting unit adjacent to the interval unit, or is coupled to the second female connection terminal of another interval unit adjacent to the interval unit. The second female connection terminal of each of the interval units is coupled to the first male connection terminal of the lighting unit adjacent to the interval unit, or is coupled to the second male connection terminal of another interval unit adjacent to the interval unit.

In the aforementioned embodiments of the present invention, since the first male connection terminal of the first end portion of the lighting unit can be coupled to the first female connection terminal of the second end portion of another lighting unit adjacent to the lighting unit, the plural lighting units can be connected in series to form the light bar. The light bar of the present invention does not need to have a printed circuit board used to a conventional LED light bar, and the SMT process does not need to apply to the light bar to solder LEDs to a printed circuit board. As a result, the manufacturing process time of the light bar is reduced, and users can assemble the light bar from the lighting units by themselves or easily replace the lighting units of the light bar.

In addition, the light emitting surfaces of the lighting units of the light bar can face the same direction or different directions, so that the light emitting angle of the light bar is increased. The light bar may include the interval units located between the lighting units, such that a distance between two adjacent lighting units can be increased, and the light emitted by the light bar has significant variability.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a light bar according to one embodiment of the present invention;

FIG. 2 is a perspective view of one of lighting units of the light bar shown in FIG. 1;

FIG. 3 is another perspective view of the lighting unit shown in FIG. 2;

FIG. 4 is a cross-sectional view of the lighting unit shown in FIG. 2 taken along line 4-4;

FIG. 5 is a perspective view of a lighting unit according to one embodiment of the present invention;

FIG. 6 is another perspective view of the lighting unit shown in FIG. 5;

FIG. 7 is a perspective view of a light bar according to one embodiment of the present invention;

FIG. 8 is a perspective view of a light bar according to one embodiment of the present invention;

FIG. 9 is a perspective view of an interval unit shown in FIG. 8;

FIG. 10 is another perspective view of the interval unit shown in FIG. 9; and

FIG. 11 is a cross-sectional view of the interval unit shown in FIG. 9 taken along line 11-11.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

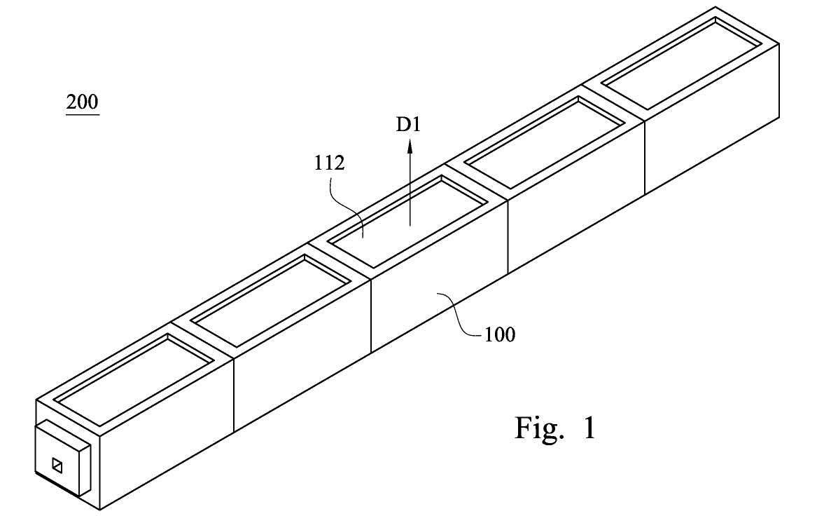

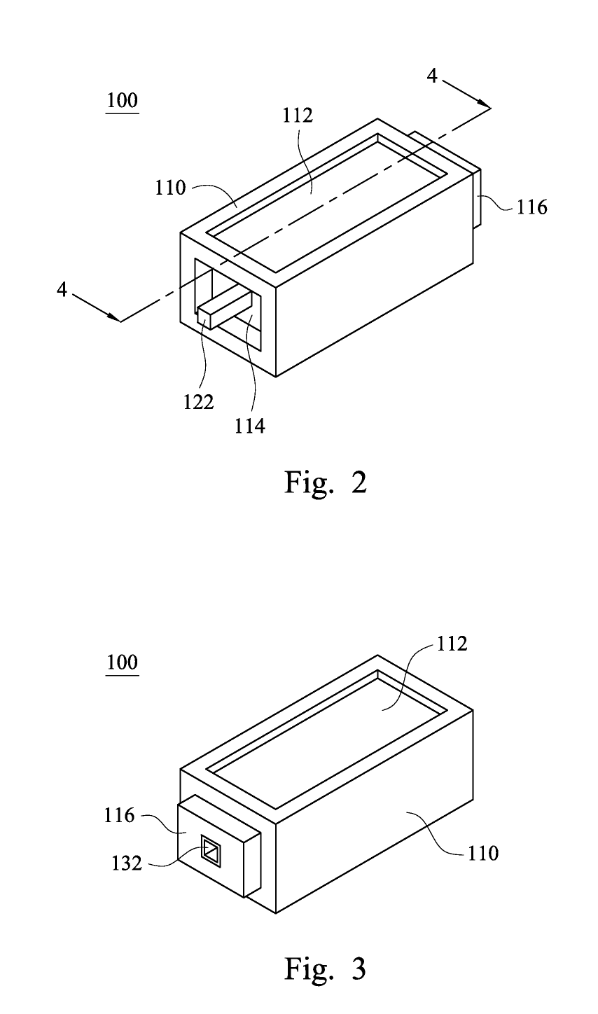

FIG. 1 is a perspective view of a light bar 200 according to one embodiment of the present invention. FIG. 2 is a perspective view of one of lighting units 100 of the light bar 200 shown in FIG. 1. As shown in FIG. 1 and FIG. 2, the light bar 200 includes N lighting units 100 that are connected in series, and N is a natural number. In this embodiment, N is equal to 5, but the present invention is not limited in this regard.

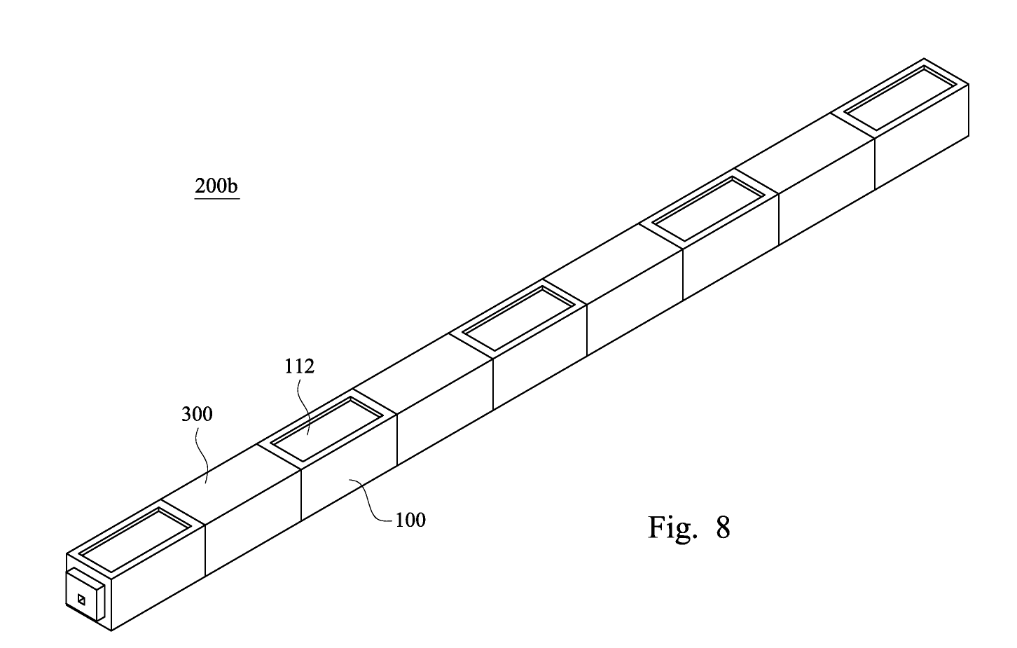

Each of the lighting units 100 includes a cup body 110 that has a light emitting surface 112. In this embodiment, the light emitting surfaces 112 of the lighting units 100 face the same direction D1, but in another embodiment, the light emitting surfaces 112 of the lighting units 100 may face different directions (see FIG. 7), and the present invention is not limited in this regard. In the following descriptions, the structure and the connection method of the lighting unit 100 will be described.

FIG. 3 is another perspective view of the lighting unit 100 shown in FIG. 2. As shown in FIG. 2 and FIG. 3, the cup body 110 of the lighting unit 100 has a first end portion 114 and a second end portion 116 facing away from the first end portion 114, and the first and second end portions 114, 116 are adjacent to the light emitting surface 112. The first end portion 114 of the cup body 110 is a concave structure, and the second end portion 116 of the cup body 110 is a protruding structure. The cross-sectional shapes of the concave structure and the protruding structure are fit together. The cross-sectional shapes include rounds or polygons. In this embodiment, the cross-sectional shapes of the concave structure and the protruding structure are quadrilaterals, such that the first end portion 114 of the lighting unit 100 can be coupled to the second end portion 116 of another lighting unit 100 adjacent to the lighting unit 100, and that the second end portion 116 of the lighting unit 100 can be coupled to the first end portion 114 of another lighting unit 100 adjacent to the lighting unit 100.

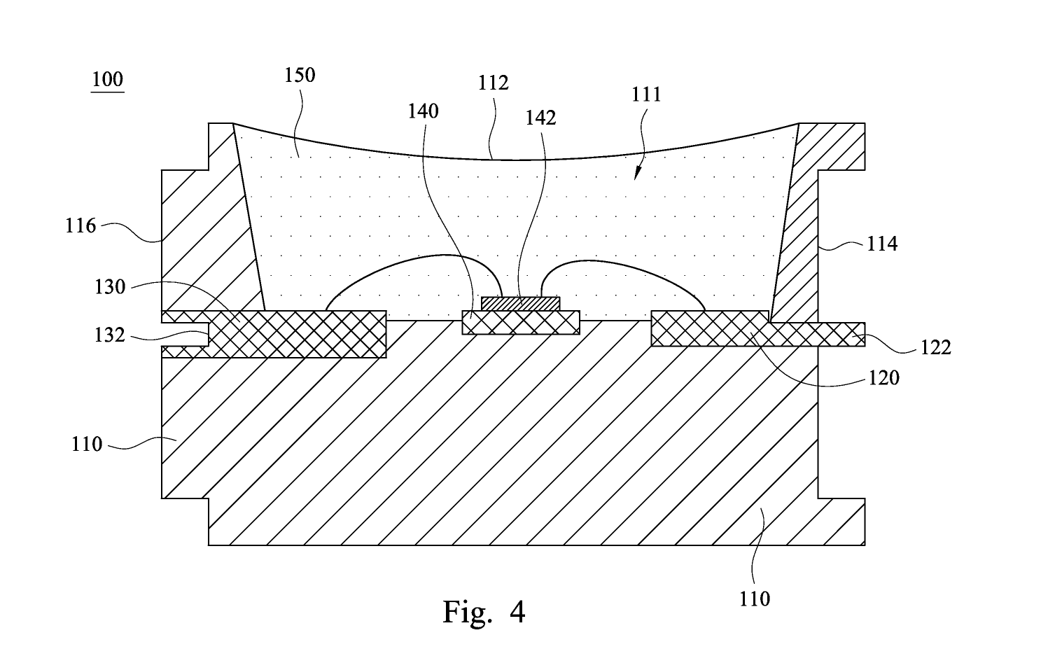

FIG. 4 is a cross-sectional view of the lighting unit 100 shown in FIG. 2 taken along line 4-4. As shown in FIG. 4, the lighting unit 100 includes the cup body 110, a substrate 140, a first conductive wire connector 120, and a second conductive wire connector 130. The cup body 110 has a concave accommodating cavity 111. The substrate 140 is located in the accommodating cavity 111. A lighting element 142 is located on the substrate 140, and the light emitting direction of the lighting element 142 is toward the light emitting surface 112 (i.e., a light emitting surface formed by an encapsulant 150 that is filled in the accommodating cavity 111). In this embodiment, the lighting element 142 may be, but not limited to a light emitting diode. The first and second conductive wire connectors 120, 130 are respectively located at two sides of the substrate 140 in the concave accommodating cavity 111. The lighting element 142 is electrically connected to the first and second conductive wire connectors 120, 130. For example, conductive wires may be used to electrically connect the lighting element 142, the first and second conductive wire connectors 120, 130. A portion of the first conductive wire connector 120 protrudes from the surface of the first end portion 114 to form a first male connection terminal 122. The second conductive wire connector 130 is recessed in the surface of the second end portion 116 to form a first female connection terminal 132.

Furthermore, the lighting unit 100 may further include the encapsulant 150. The encapsulant 150 is formed on the lighting element 142 (e.g., a light emitting diode), and may be filled in the accommodating cavity 111 depending on product requirements of designers'. The encapsulant 150 may include transparent resin and further include a wavelength conversion material mixed with the transparent resin. The wavelength conversion material may be phosphor, pigment, dye, or combinations thereof. When the lighting element 142 emits light, the wavelength conversion material of the encapsulant 150 can change the wavelength of the light emitted by the lighting element 142. For example, the lighting element 142 is a blue light emitting diode, and the encapsulant 150 has yellow phosphor. When the lighting element 142 emits light, the light emitting surfaces 112 emits white light mixed by blue light and yellow light.

As shown in FIG. 1 and FIG. 4, the light bar 200 can utilize the first male connection terminal 122 of the first end portion 114 of the i-th lighting unit 100 to couple to the first female connection terminal 132 of the second end portion 116 of the j-th lighting unit 100 adjacent to the i-th lighting unit 100, such that the i-th lighting unit 100 is electrically connected to the j-th lighting unit 100 adjacent to the i-th lighting unit 100. 1≦i≦j≦N, and i and j are positive integers. Moreover, since the first end portion 114 of the lighting unit 100 can be coupled to the second end portion 116 of another lighting unit 100 adjacent to the lighting unit 100, the plural lighting units 100 can be connected in series to form the light bar 200 by the first male connection terminal 122, the first female connection terminal 132, and the first and second end portions 114, 116, and the lighting units 100 are electrically connected with each other. In operation, the two lighting units 100 respectively located at the two ends of the light bar 200 may be electrically connected an external power by the first male connection terminal 122 and the first female connection terminal 132, such that all of the lighting elements 142 of the light bar 200 can receive electric power.

As a result, the light bar 200 does not need to have a printed circuit board used to a conventional LED light bar, and the surface mount technology (SMT) process also does not need to apply to the light bar 200 to solder LEDs to a printed circuit board. Therefore, the manufacturing process time of the light bar 200 is reduced, and users can assemble the light bar 200 from the lighting units 100 by themselves. Moreover, when the light bar 200 is used for a long period of time, a portion of the lighting units 100 may be damaged or the brightness of the lighting units 100 may be reduced. Users can detach the light bar 200 by themselves to replace the lighting units 100 having problems.

In the following descriptions, other types of the first and second end portions 114, 116 will be described.

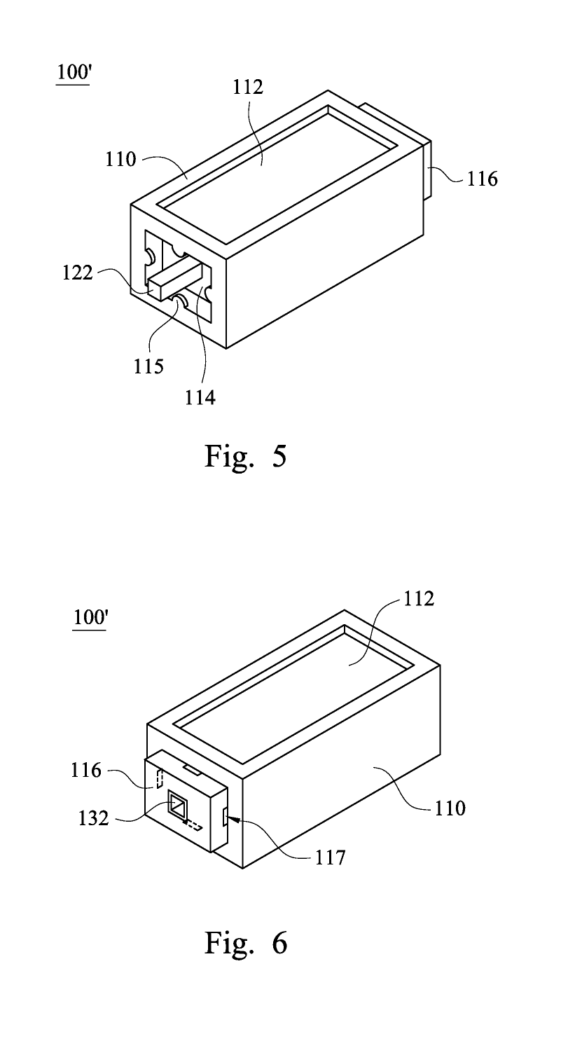

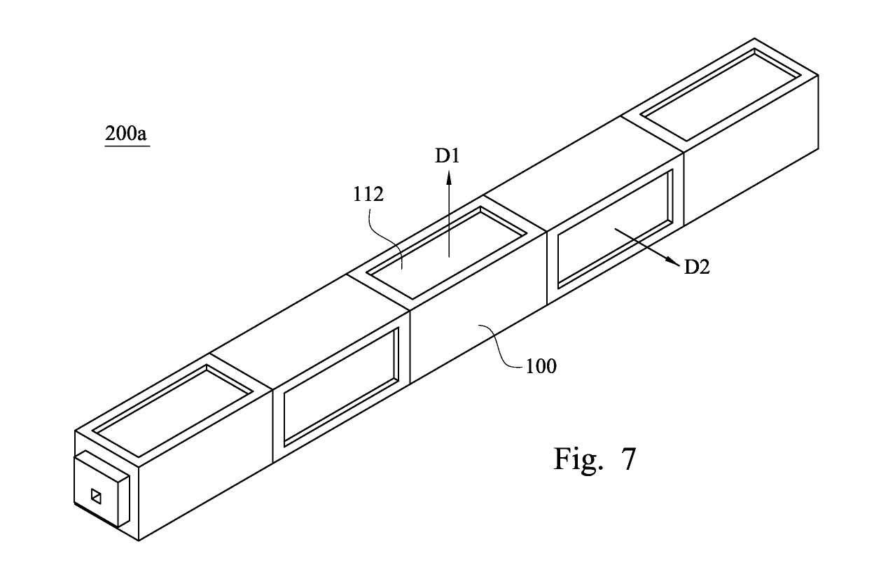

FIG. 5 is a perspective view of a lighting unit 100′ according to one embodiment of the present invention. FIG. 6 is another perspective view of the lighting unit 100′ shown in FIG. 5. As shown in FIG. 5 and FIG. 6, the cup body 110 of the lighting unit 100′ has the first end portion 114 and the second end portion 116 facing away from the first end portion 114, and the first end portion 114 is a concave structure, while the second end portion 116 is a protruding structure. The differences between this embodiment and the embodiment shown in FIGS. 2 and 3 are that: the surface of the concave structure has a positioning protruding part 115, and the protruding structure has a positioning cavity 117. For example, the positioning protruding part 115 may be on the inner side surface of the concave structure, and the positioning cavity 117 may be on the outer side surface of the protruding structure. When the first end portion 114 of the lighting unit 100′ is coupled to the second end portion 116 of another lighting unit 100′ adjacent to the lighting unit 100′, or when the second end portion 116 of the lighting unit 100′ is coupled to the first end portion 114 of another lighting unit 100′ adjacent to the lighting unit 100′, the positioning protruding part 115 can be coupled to the positioning cavity 117, such that the plural lighting units 100′ can be firmly connected with each other.

It is to be noted that the connection relationships and materials of the elements described above will not be repeated in the following descriptions, and only aspects related to other types of the light bar 200 (see FIG. 1) will be described.

FIG. 7 is a perspective view of a light bar 200a according to one embodiment of the present invention. The light bar 200a are formed by the lighting units 100 that are connected in series. The difference between this embodiment shown in FIG. 7 and the embodiment shown in FIG. 1 is that some of the light emitting surfaces 112 face a direction D1 and some of the light emitting surfaces 112 face a direction D2 in FIG. 7. That is to say, the light emitting surfaces 112 of the lighting units 100 may face different directions D1, D2. In another embodiment, the light emitting surfaces 112 of the lighting units 100 may selectively face a direction reverse to the direction D1 or reverse to the direction D2. In another embodiment, the light emitting surfaces 112 of the lighting units 100 face the direction D1 and the direction D2 perpendicular to the direction D1 (see FIG. 7). The directions of the light emitting surfaces 112 may be determined in accordance with practical requirements.

As shown in FIG. 1 and FIG. 7, the lighting units 100 of the light bar 200, 200a may be the same, as long as the cross-sectional shapes of the first and second end portions 114, 116 (see FIGS. 2 and 3) are coupling squares or coupling rounds, and the cross-sectional shapes of the first male connection terminal 122 (see FIG. 2) and the first female connection terminal 132 (see FIG. 3) are squares or rounds to fit together. When the lighting units 100 is assembled, users can selectively determine the directions of the light emitting surfaces 112 of the lighting units 100 being the same or different. Therefore, the light emitting angles of the light bars 200, 200a can be improved.

FIG. 8 is a perspective view of a light bar 200b according to one embodiment of the present invention. The light bar 200b are also formed by the lighting units 100 that are connected in series. The difference between this embodiment and the embodiment shown in FIG. 1 is that the light bar 200b further includes a plurality of interval units 300. The interval units 300 are located between the lighting units 100. In the following descriptions, the structure and the connection method of the interval unit 300 will be described.

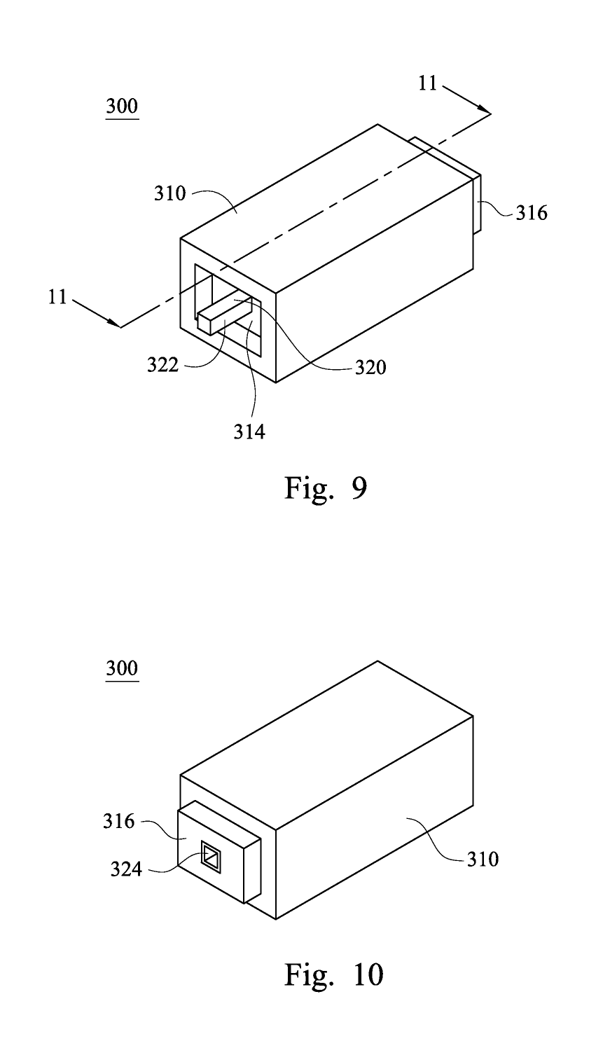

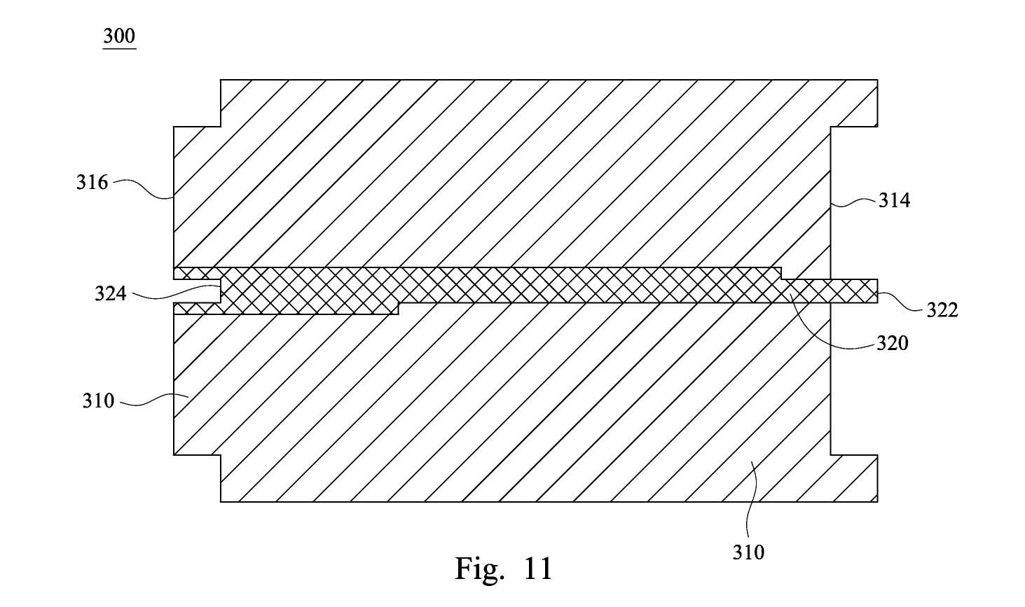

FIG. 9 is a perspective view of the interval unit 300 shown in FIG. 8. FIG. 10 is another perspective view of the interval unit 300 shown in FIG. 9. The interval unit 300 includes a second cup body 310. The second cup body 310 has a third end portion 314, a fourth end portion 316 facing away from the third end portion 314. The third end portion 314 is a concave structure, and the fourth end portion 316 is a protruding structure. The cross-sectional shapes of the concave structure and the protruding structure are fit together and include rounds or polygons.

In this embodiment, the cross-sectional shapes of the concave structure and the protruding structure are quadrilaterals. The third end portion 314 of the interval unit 300 can be coupled to the second end portion 116 of the lighting unit of FIG. 3, or coupled to the fourth end portion 316 of another interval unit 300 adjacent to the interval unit 300. Moreover, the fourth end portion 316 of the interval unit 300 can be coupled to the first end portion 114 of the lighting unit of FIG. 3, or coupled to the third end portion 314 of another interval unit 300 adjacent to the interval unit 300.

FIG. 11 is a cross-sectional view of the interval unit 300 shown in FIG. 9 taken along line 11-11. As shown in FIG. 4 and FIG. 11, the second cup body 310 has a conductive element 320 therein. An end of the conductive element 320 protrudes from the third end portion 314 to form a second male connection terminal 322, and another end of the conductive element 320 is recessed in the fourth end portion 316 to form a second female connection terminal 324. During assembly, the second male connection terminal 322 of the interval unit 300 may be coupled to the first female connection terminal 132 of the lighting unit 100 adjacent to the interval unit 300, or coupled to the second female connection terminal 324 of another interval unit 300 adjacent to the interval unit 300. Furthermore, the second female connection terminal 324 of the interval unit 300 may be coupled to the first male connection terminal 122 of the lighting unit 100 adjacent to the interval unit 300, or coupled to the second male connection terminal 322 of another interval unit 300 adjacent to the interval unit 300.

Referring to FIG. 8, since the light bar 200b has the interval units 100 located between the lighting units 100, a distance between two adjacent lighting units 100 can be increased, such that the type of the light emitted by the light bar 200b has significant variability and flexibility.

Compared with the aforesaid embodiments and prior arts, the light bar of the present invention does not need to have a printed circuit board used to a conventional LED light bar, and the SMT process does not need to apply to the light bar to solder LEDs to a printed circuit board. As a result, the manufacturing process time of the light bar can be reduced, and users can assemble the light bar from the lighting units by themselves or easily replace the lighting units of the light bar. In addition, the light emitting surfaces of the lighting units of the light bar may face the same direction or different directions, so that the light emitting angle of the light bar is increased. The light bar may further include the interval units located between the lighting units, such that a distance between two adjacent lighting units of the light bar can be increased, and the type of the light emitted by the light bar has significant variability and flexibility.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A lighting unit comprising:
a cup body having a light emitting surface, a first end portion, and a second end portion facing away from the first end portion, wherein the first and second end portions are adjacent to the light emitting surface, and the cup body has a concave accommodating cavity;
a substrate located in the accommodating cavity, wherein a lighting element is located on the substrate and has a light emitting direction toward the light emitting surface; and
a first and a second conductive wire connectors respectively located at two sides of the substrate in the concave accommodating cavity, wherein the lighting element is electrically connected to the first and second conductive wire connector, a portion of the first conductive wire connector protrudes from a surface of the first end portion to form a first male connection terminal, and the second conductive wire connector is recessed in a surface of the second end portion to form a first female connection terminal.

2. The lighting unit of claim 1, wherein the first end portion of the cup body is a concave structure, and the second end portion of the cup body is a protruding structure.

3. The lighting unit of claim 2, wherein a surface of the concave structure further has a positioning protruding part, and the protruding structure has a positioning cavity.

4. The lighting unit of claim 3, wherein cross-sectional shapes of the concave structure and the protruding structure comprise rounds or polygons to fit together.

5. The lighting unit of claim 1, wherein the lighting element is a light emitting diode.

6. The lighting unit of claim 5, further comprising:
an encapsulant formed on the light emitting diode.

7. The lighting unit of claim 6, wherein the encapsulant further comprises a wavelength conversion material.

8. The lighting unit of claim 7, wherein the wavelength conversion material comprises phosphor, pigment, dye, or combinations thereof.

9. A light bar comprising N lighting units that are connected in series of claim 1, wherein N is a natural number, and the first male connection terminal of the first end portion of the i-th lighting unit is coupled to the first female connection terminal of the second end portion of the j-th lighting unit adjacent to the i-th lighting unit, such that the i-th lighting unit is electrically connected to the j-th lighting unit adjacent to the i-th lighting unit, 1≦i≦j≦N, and i and j are positive integers.

10. The light bar of claim 9, wherein the light emitting surfaces of the lighting units faces the same direction or different directions.

11. The light bar of claim 10, further comprising:
a plurality of interval units located between the lighting units, wherein each of the interval units comprises:
a second cup body having a third end portion, a fourth end portion facing away from the third end portion, and a conductive element therein, wherein an end of the conductive element protrudes from the third end portion to form a second male connection terminal, and another end of the conductive element is recessed in the fourth end portion to form a second female connection terminal,
wherein the second male connection terminal of each of the interval units is coupled to the first female connection terminal of the lighting unit adjacent to the interval unit, or is coupled to the second female connection terminal of another interval unit adjacent to the interval unit; the second female connection terminal of each of the interval units is coupled to the first male connection terminal of the lighting unit adjacent to the interval unit, or is coupled to the second male connection terminal of another interval unit adjacent to the interval unit.

12. The light bar of claim 9, wherein the first end portion of the cup body is a concave structure, and the second end portion of the cup body is a protruding structure.

13. The light bar of claim 12, wherein a surface of the concave structure further has a positioning protruding part, and the protruding structure has a positioning cavity.

14. The light bar of claim 13, wherein cross-sectional shapes of the concave structure and the protruding structure comprise rounds or polygons to fit together.

15. The light bar of claim 9, wherein the lighting element is a light emitting diode.

16. The light bar of claim 15, further comprising:
an encapsulant formed on the light emitting diode.

17. The light bar of claim 16, wherein the encapsulant further comprises a wavelength conversion material.

18. The light bar of claim 17, wherein the wavelength conversion material comprises phosphor, pigment, dye, or combinations thereof.
